(19) United States
(12) Patent Application Publication
(10) Pub. No.: US 2004/0131107 A1
(43) Pub. Date: Jul. 8, 2004

(54) Adaptive turbo multiuser detection for HSDPA/TDD CDMA with unknown interferers

(75) Inventor: Jin Wang, Central Islip, NY (US)

Correspondence Address: VOLPE AND KOENIG, P.C., DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE

(21) Appl. No.: 10/721,559

(22) Filed: Nov. 25, 2003

Related U.S. Application Data
(60) Provisional application No. 60/429,365, filed on Nov. 26, 2002.

(51) Int. Cl. H04K 1/00; H04B 1/707

(52) U.S. Cl. 375/144

(57) ABSTRACT

A novel adaptive Bayesian multi-user receiver demodulating multi-user symbols in an HSDPA/TDD system in the presence of additive white Gaussian noise, unknown inter-cell interference (ICI), multi-access interference (MAI) and inter-symbol interference (ISI).

### CROSS REFERENCE TO RELATED APPLICATION(S)

This application claims priority from U.S. Provisional Application No. 60/429,365, filed on Nov. 26, 2002, which is incorporated by reference as if fully set forth.

### FIELD OF INVENTION

The present invention is related to wireless communication systems. More particularly, the present invention is related to multi-user detection for demodulating multi-user systems in high speed downlink access.

### BACKGROUND

High Speed Downlink Packet Access (HSDPA) for Universal Mobile Telecommunications Systems-Wideband Code Division Multiple Access (UMTS WCDMA) both Time Division Duplex (TDD) and Frequency Division Duplex (FDD) modes has been proposed to provide very high data rate packet service. HSDPA has the capability to adaptively adjust the transmission data rate according to varying channel conditions. In the UTRA-TDD mode, due to the asymmetric allocation of uplink and downlink timeslots, the performance of User Equipment (UE) using HSDPA service can be seriously degraded by unknown inter-cell interferences. This will impact the overall spectrum efficiency of HSDPA/TDD mode.

FIG. 1 shows a typical example of an interference scenario in a TDD communication system between two neighboring cells, (Cell 1 and Cell 2), having two base stations BS1 and BS2, respectively, using the same frequency band but having different uplink/downlink asymmetric traffic. A second mobile station (MS2) is close the border of both cells (Cell 1 and Cell 2) and communicates with full power to the second base station BS2. A first mobile station (MS1) communicates with the first base station BS1 and is also close to the border of the cells (Cell 1 and Cell 2). In this case, an uplink transmission from MS2 to BS2 can block the downlink transmission from BS1 to MS1 which causes the inter-cell interference.

FIG. 2 shows one frame of a communication between MS1 and BS1 and from MS2 and BS2. It should be noted that the slots five (5) through nine (9) in the downlink (DL) portion of the communication between MS1 and BS1 directly overlaps with the uplink slots five (5) through nine (9) of the uplink communication between MS2 and BS2. As described before, there exists a need to demodulate the multi-user symbols in an HSDPA/TDD system in the presence of unknown inter-cell interference, multiple-access interference (MAI) and inter-symbol interference (ISI).

### SUMMARY

The present invention uses a novel, adaptive Bayesian multi-user detector to demodulate the multi-user symbols in a HSDPA/TDD system in the presence of unknown inter-cell MAI and ISI.

### BRIEF DESCRIPTION OF THE DRAWING(S)

FIG. 1 is a prior art diagram useful in explaining inter-cell interference between two cells.

FIG. 2 shows uplink/downlink frames of communications between respective Mobile Stations (MSs), shown in FIG. 1 and one of the Base Stations (BSs) in FIG. 1.

FIG. 3 is a block diagram showing the transmitter of an HSDPA/TDD communication system.

FIG. 4 is a block diagram of the blind turbo multi-user receiver for joint adaptive Bayesian detection and turbo decoding in the multi-user environment.

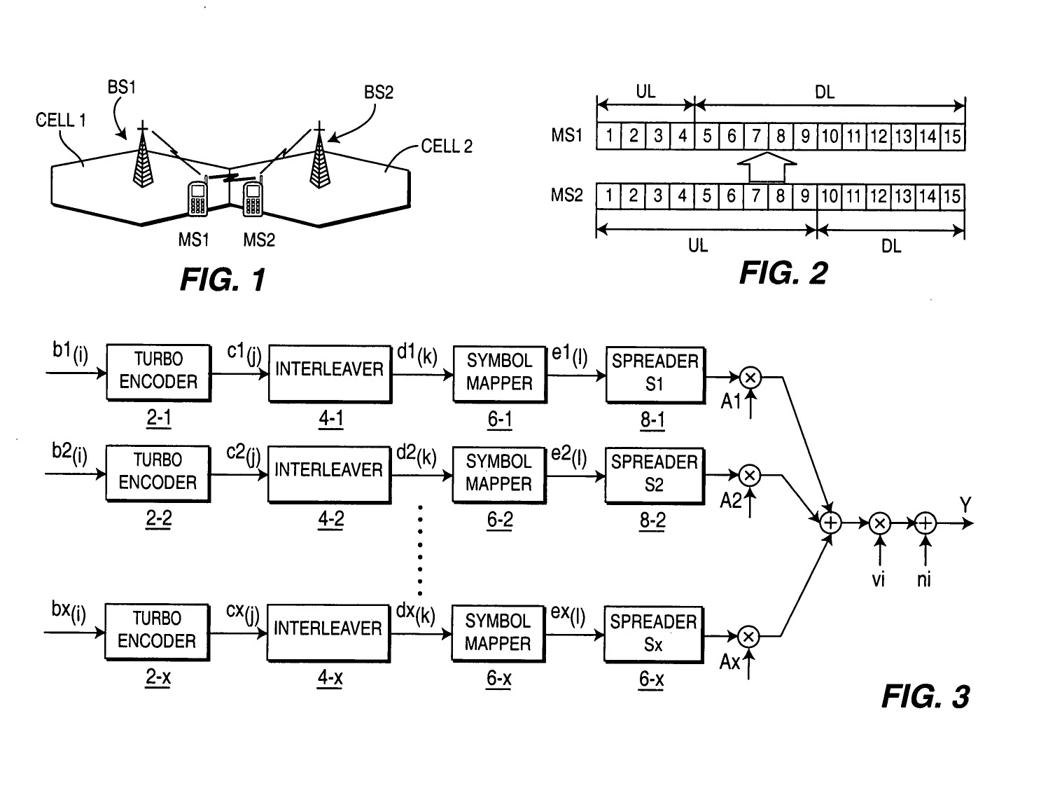

### DETAILED DESCRIPTION OF THE PREFERRED EMBODIMENT(S)

The present invention will be described with reference to the drawing figures wherein like numerals represent like elements throughout.

Many statistical signal processing problems found in wireless communications involve making inferences about the transmitted information based on the received signals, in the presence of various unknown channel distortions. The optimal solutions to these problems are typically computationally too complex to implement using conventional signal processing methods. However, the Monte Carlo signal processing methods and the relatively simple, but extremely powerful numerical techniques for Bayesian computation provide a novel paradigm for tackling these problems.

The adaptive Bayesian multi-user detector of a HSDPA/TDD system in accordance with the present invention makes the estimation by computing the a posteriori probability {P[xₓ=+1|R]}ₓ for the multi-user symbols. Such a detector is based on the Bayesian inference of all unknown parameters. The Gibbs sampler, a Markov chain Monte Carlo (MCMC) technique which is well known in the prior art, is employed for Bayesian estimates. The Gibbs sampler, which is extensively covered in the literature and a detailed description of which has been omitted for purposes of brevity, provides a very powerful Bayesian solution.

Let θ=[θ₁,η₂, . . . θₓ]^{T} be a vector of unknown parameters, Y be the observed data. The Gibbs sampler algorithm can be described as follows:

a) For i=1, . . . x, we draw θᵢ⁽ⁱ⁺¹⁾ from the conditional distribution p(θᵢ⁽ⁿ⁺¹⁾|θ₁⁽ⁿ⁺¹⁾, . . . θᵢ₋₁⁽ⁿ⁺¹⁾,θᵢ₊₁⁽ⁿ⁾, . . . θ_{d}⁽ⁿ⁾,Y).

It is known that under regularity conditions,

b) The distribution of θⁿ converges geometrically to p[θ|Y], as n→∞,

c)

$$c ) \frac{1}{N} {\sum }_{n = 1}^{N} f ( {θ}^{( n )} ) {⟶}^{a . s .} \int f ( θ ) p [ θ \vert Y ] ⅆ θ ,$$

as n→∞, for any integrable function f.

Being soft-input and soft-output in nature, this adaptive multi-user detector easily fits into a turbo receiver framework and exchange the extrinsic information with a maximum a posteriori (MAP) turbo decoder to successively refine the performance in a coded CDMA system.

A block diagram of transmitter for use in an HSDPA/TDD communication system is shown in FIG. 3.

Since the circuitry for operating on bits b1(i)-bₓ(i) is substantially the same, only one of the circuits bₓ(i), will be described in detail for simplicity. The binary information bits bₓ(i) for user X are turbo encoded through turbo encoder 2-x, having an output which provides a code bit stream cₓ(j). A code bit interleaver 4-x is used to reduce the bursty error problem. The interleaved code bits dₓ(k) are then mapped to QPSK symbols through the symbol mapper 6-x which generates symbol stream eₓ(1). Then each data symbol is modulated by a spreading sequence sₓ through spreader Sₓ8-x and then transmitted through the channel. The received signal is the superposition of the X user's transmitted signals. In FIG. 3, A₁-Aₓ are the transmitted amplitude of users from 1 to x, vᵢ is the fading channel coefficient, nᵢ is the complex white Gaussian noise with zero mean.

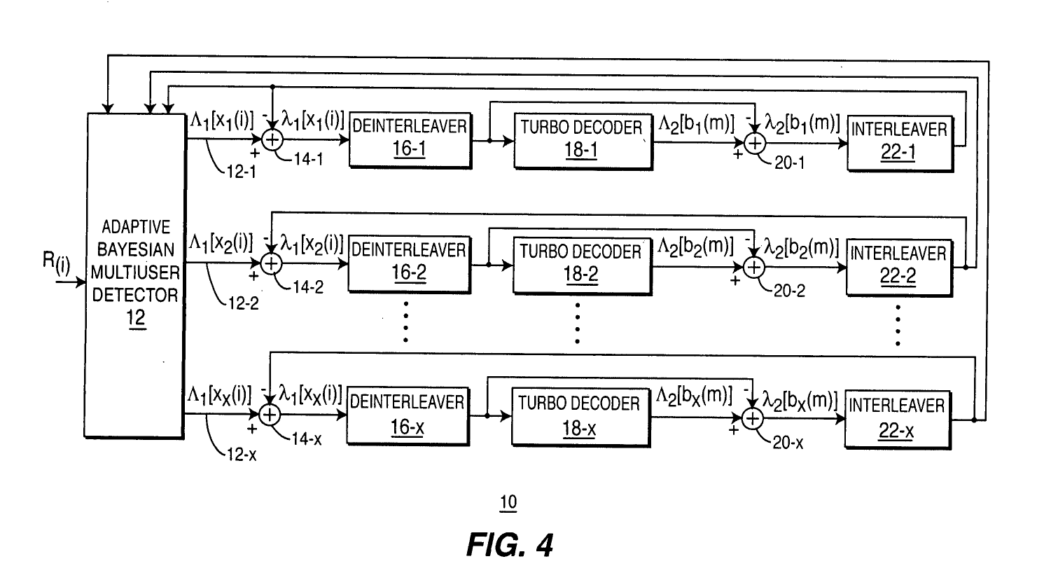

A block diagram of the blind turbo multi-user receiver in the HSDPA/TDD scenario is shown in FIG. 4.

The blind turbo multi-user receiver 10 of FIG. 4 comprises two (2) components: (1) an adaptive Bayesian multi-user detector 12 followed by (2) a bank of maximum a posteriori probability (MAP) Turbo decoders, 18-1 through 18-x. These two (2) components are separated by the deinterleavers 16 and interleavers 22. The first component 12 which is the detector, receives the signal R(i) and employs an adaptive Bayesian multi-user detection method, to generate outputs Λ₁[x₁(i)] (12-1) through Λ₁[xₓ(i)] (12-x).

Each of these outputs is applied to an associated summing circuit 14-1 through 14-x where they sum together with an output from an associated interleaver circuit 22-1 through 22-x, (each output from 22-1 through 22-x is respectively subtracted from each output from 12-1 through 12-x), the output of each of the aforesaid interleavers also being applied as inputs to the detector 12.

The result of each summation operation, λ₁[x₁(i)] through λ₁[xₓ(i)] at units 14-1 through 14-x is applied to an associated deinterleaver 16-1 through 16-x.

The outputs of each of the deinterleavers 16-1 through 16-x are applied as inputs to an associated MAP Turbo decoder 18-1 through 18-x and to an associated summing circuit 20-1 through 20-x. Each summing circuit 20-1 through 20-x sums the output of each of the Turbo decoders 18-1 through 18-x which is Λ₂[x₁(i)] through Λ₂[xₓ(i)], with the outputs of the deinterleavers 16-1 through 16-x respectively and each generates an output λ₂[b₁(m)] through λ₂[bₓ(m)]. These outputs are applied to an associated interleaver 22-1 through 22-x, mentioned hereinabove, each of which couples one of its outputs to an associated one of the summing circuits 14-1 through 14-x as well as an associated input to the adaptive Bayesian multi-user detector 12. It should be noted that the outputs of each interleaver 22-1 through 22-x is subtracted from the outputs applied to summing circuits 14-1 through 14-x by detector 12. Similarly, the outputs of the deinterleavers 16-1 through 16-x are subtracted from the outputs of the Turbo decoders 18-1 through 18-x and are then inputted to summing devices 20-1 through 20-x.

The adaptive Bayesian multi-user detector 12 computes a posteriori symbol probabilities {P[xₓ=+1|R]}ₓ. Based on them, a posteriori log-likelihood ratios (LLR's) of a transmitted symbol “+1” and a transmitted symbol “−1” is first computed and outputted from detector 12, the calculation formula being shown in Equation (1).

$${Λ}_{1} [ {x}_{x} ] = log \frac{P [ {x}_{x} = + 1 \vert R ]}{P [ {x}_{x} = - 1 \vert R ]} \qquad Equation ( 1 )$$

In terms of the Bayes' rule, the above equation can be written as:

$${Λ}_{1} [ {x}_{x} ] = \underbrace{log \frac{P [ R \vert {x}_{x} = + 1 ]}{P [ R \vert {x}_{x} = - 1 ]}}_{{{λ}_{1} [ {x}_{x} ]}_{1}} + \underbrace{log \frac{P [ {x}_{x} = + 1 ]}{P [ {x}_{x} = - 1 ]}}_{{{λ}_{2}^{p} [ {x}_{x} ]}_{1}} \qquad Equation ( 2 )$$

The second term in Equation (2), which is denoted by λ₂^{p}[xₓ], represents the a priori LLR of the code bits xₓ, which are calculated by the decoders 18-1 through 18-x in the previous iteration, interleaved by 22-1 through 22-x, and then fed back to the Bayesian multi-user detector 12. (The superscript ^{p} indicates the quantity obtained from the previous iteration). For the first iteration, when assuming equally likely code bits which means there is no prior information available, we have λ₂^{p}[xₓ]=0. The first term in Equation (2), which is denoted by λ₁[xₓ], represents the extrinsic information delivered by the Bayesian multi-user detector 12 in terms of the received signals R[i] and the prior information about all other code bits.

The extrinsic information λ₁[x₁] to λ₁[xₓ] which is not influenced by the a priori information λ₂^{p}[x₁] to λ₂^{p}[xₓ] provided by the turbo decoders 18-1 through 18-x is then de-interleaved by 16-1 through 16-x and fed into the turbo decoder 18-1 through 18-x. Based on the extrinsic information of the code bits, λ₂^{p}[x₁] to λ₂^{p}[xₓ] is extracted and fed back to the Bayesian multi-user detector 12 as a priori information in the next iteration. The multi-user symbols are derived from outputs 12-1 to 12-x after a suitable number of iterations.

The turbo multi-user receiver technique can adaptively and efficiently reduce the inter-cell interference without knowing the spreading codes from the adjacent cells while reducing the intra-cell interference. This simplifies the algorithms of dynamic channel allocation (DCA). As a blind estimation and detection technique, it infers and estimates the unknown channel parameters without any prior training sequences, and leads to the potential removal of a midamble which is used in the UTRA TDD mode and which consumes up to 25% of the bandwidth. The combination of interference reduction and midamble removal greatly improves the spectrum efficiency of the system.

What is claimed is:

1. A method employed by a multi-user receiver to adaptively detect multi-user symbols, said multi-user symbols being subject to impairments occurring in a radio channel which impairments comprise inter-cell interference (ICI), an effective white Gaussian noise, multiple access interference (MAI) and inter-symbol interference (ISI), comprising:
a) employing a novel Markov Chain Monte Carlo (MCMC) procedure using a Gibbs sampler to adaptively detect the multi-user symbols responsive to the unknown channel responses.

2. The method of claim 1 further comprising:
a) employing maximum a posteriori probability (MAP) estimations obtained by a turbo decoder.

3. The method of claim 2 further comprising:
a) exchanging extrinsic information with the turbo decoder to successively refine the performance.

4. The method of claim 1 wherein the received symbols are communicated in CDMA.

5. The method of claim 1 wherein adaptive Bayesian multi-user detector and turbo decoder are performed on high speed downlink packet access (HSDPA) in a time division duplex (TDD) system.

6. The method of claim 1 wherein the turbo decoding function comprises:
a) deinterleaving a difference between a multi-user estimate and an interleaved quantity;
b) turbo decoding the de-interleaved quantity;
c) subtracting from the decoded quantity the deinterleaved quantity; and
d) subtracting the interleaved quantity from the multi-user estimate.

7. The method of claim 6 wherein the result from step (i) is employed to successively refine the multi-user estimate.

8. An apparatus employed by a multi-user receiver to adaptively detect multi-user symbols, said multi-user symbols being subject to impairments occurring in a radio channel which impairments comprise inter-cell interference (ICI), and effective white Gaussian noise, multiple access interference (MAI) and inter-symbol interference (ISI), comprising:
employing a novel Markov Chain Monte Carlo (MCMC) procedure using a Gibbs sampler to adaptively detect the multi-user symbols responsive to the unknown channel responses.

9. The apparatus of claim 8, further comprising:
a turbo decoder having means employing maximum a posteriori probability (MAP) estimations.

10. The apparatus of claim 9, further comprising:
means for exchanging extrinsic information with the turbo decoder to successively refine the performance.

11. The apparatus of claim 8 further comprising means for receiving said symbols in CDMA.

12. The apparatus of claim 8 employing an adaptive Bayesian multi-user detector and said turbo decoder for operating in high speed downlink packet access (HSDPA) in a time division duplex (TDD) system.

13. The apparatus of claim 8 wherein the turbo decoder comprises:
means for deinterleaving a difference between a multi-user estimate and an interleaved quantity;
means for turbo decoding the de-interleaved quantity;
first means for subtracting from the decoded quantity the deinterleaved quantity; and
second means for subtracting the interleaved quantity from the multi-user estimate.

14. The apparatus of claim 13 further comprising means for employing an output of said second subtracting means to refine the multi-user estimate.

15. Apparatus for adaptively detecting multi-user symbols, comprising:
an adaptive Bayesian multi-user detector;
an interleaver;
a deinterleaver;
a turbo decoder;
a first summing circuit for subtracting an output of the interleaver from an output of the detector;
said deinterleaver having an input receiving an output of the first summing circuit and output coupled to an input of said turbo decoder;
a second summing circuit for subtracting an output of said deinterleaver from said turbo decoder;
said interleaver having an input receiving an output of said second summing circuit; and
the output of said interleaving being further coupled to an input of said detector for refining the output of said detector.

16. The apparatus of claim 15 wherein said turbo decoder comprises:
means employing a novel Markov Chain Monte Carlo (MCMC) procedure using a Gibbs Sampler to adaptively detect the multi-user symbols responsive to the unknown channel responses.
